(19) United States
(12) Patent Application Publication
(10) Pub. No.: US 2010/0242390 A1
(43) Pub. Date: Sep. 30, 2010

(54) VENTILATED BUILDING BLOCK WITH DRAIN FEATURE

(76) Inventor: Mark E. LEE LUM, Maraval (TT)

Correspondence Address: NIXON & VANDERHYE, PC, 901 NORTH GLEBE ROAD, 11TH FLOOR, ARLINGTON, VA, 22203, US

(21) Appl. No.: 12/814,119

(22) Filed: Jun. 11, 2010

Related U.S. Application Data
(63) Continuation-in-part of application No. 12/292,376, filed on Nov. 18, 2008, now Pat. No. 7,757,451.

(51) Int. Cl. E04B 1/70; E04C 1/39; E04B 2/46; B29C 39/26

(52) U.S. Cl. 52/302.1; 52/561; 249/63

(57) ABSTRACT

A building block for a ventilated wall includes an elongated center portion flanked by a pair of substantially parallel side walls oriented substantially perpendicularly to the center portion. The center portion has upper and lower edges, a first substantially vertical rear wall and a second substantially vertical front wall, the substantially parallel side walls extending beyond the second substantially vertical front wall. A first drain groove portion extends across the substantially vertical front wall and aligned with second and third drain groove portions provided on respective facing surfaces of the substantially parallel side walls.

This application is a continuation-in-part of application Ser. No. 12/292,376 filed Nov. 18, 2008.

The invention relates to a building block construction, and more specifically, to a self-ventilating block with weather inhibiting, privacy and moisture drainage features.

### BACKGROUND OF THE INVENTION

Currently, typical concrete ventilating blocks are formed with straight, internal passages extending vertically through the block, such that when plural blocks are stacked, a ventilating “chimney” is formed. These and other block constructions are well represented in the patent literature. For example, U.S. Pat. No. 2,137,153 discloses ventilated wall blocks that are stacked vertically in an alternately inverted orientation, establishing both vertical and horizontal vent passageways. In U.S. Pat. No. 7,096,634, a block is disclosed that, when stacked, creates vertical vents or cores. Still other block constructions are disclosed in U.S. Pat. Nos. 1,758,757; 2,624,193; and 4,823,530. There remains a need, however, for a horizontally-vented block for use in wall constructions that allows horizontal air circulation through the wall; inhibits rain from passing through the wall; and enhances the privacy of persons on the interior side of the wall. It would also be desirable to have a drain feature that would prevent most if not all moisture (in the form of horizontal rain, for example) from passing through the wall to the interior space behind the wall.

### BRIEF DESCRIPTION OF THE INVENTION

In accordance with an exemplary but nonlimiting embodiment of the invention, there is provided a building block comprising an elongated center portion flanked by a pair of substantially parallel side walls oriented substantially perpendicularly to the center portion, the center portion having upper and lower edges, a first substantially vertical rear wall and a second substantially vertical front wall, the substantially parallel side walls extending beyond the second substantially vertical front wall; and a first drain groove portion extending across the substantially vertical front wall and aligned with second and third drain groove portions provided on respective facing surfaces of the substantially parallel side walls.

In another aspect, the invention relates to a building block for a ventilated wall comprising an elongated center portion flanked by a pair of substantially parallel side walls oriented substantially perpendicularly to the center portion, the center portion having upper and lower edges, and the side walls having upper and lower edges substantially flush with the upper and lower edges of the center portion, the center portion further comprising a first substantially vertical rear wall and a second substantially vertical front wall, the substantially parallel side walls extending beyond the second substantially vertical front wall; and a first drain groove portion extending across the substantially vertical front wall between the upper and lower edges of the center portion and aligned with second and third drain groove portions provided on respective facing surfaces of the substantially parallel side walls, the second and third drain groove portions extending to forward edges of the side walls; the first, second and third drain groove portions configured to carry moisture by gravity to the forward edges of the side walls.

In still another embodiment, the invention relates to a wall unit comprising at least first and second building blocks, each building block having an elongated center portion flanked by a pair of substantially parallel side walls oriented substantially perpendicularly to the center portion, the center portion having upper and lower edges, a first substantially vertical rear wall and a second substantially vertical front wall, the substantially parallel side walls extending beyond the second substantially vertical front wall; and a first drain groove portion extending across the substantially vertical front wall and aligned with second and third drain groove portions provided on respective facing surfaces of the substantially parallel side walls, the second and third drain groove portions extending to forward edges of the side walls; and wherein the at least first and second building blocks are stacked one on the other, with the second block inverted and reversed relative to the first block.

In still another aspect, the invention relates to a mold assembly for forming a ventilated construction block, the mold assembly comprising a mold core having a centrally-located block portion attached to an underside of a core plate portion, the block portion having a substantially vertical surface and a pair of side surfaces; and an undercut, substantially horizontal groove extending along the substantially vertical surface and continuing along the pair of side surfaces, the undercut groove sloping downwardly from a vertical center axis of the block portion of the mold core.

The invention will now be described in detail in connection with the drawings identified below.

### BRIEF DESCRIPTION OF THE DRAWINGS

FIG. 1 is a top, left perspective view of a concrete block in accordance with an exemplary embodiment of the invention;

FIG. 2 is a right, rear perspective of the block shown in FIG. 1;

FIG. 3 is a front elevation view of the block shown in FIGS. 1 and 2;

FIG. 4 is a top plan view of the block shown in FIGS. 1 and 2;

FIG. 5 is a right side elevation of the block shown in FIG. 4;

FIG. 6 is a perspective view of the exterior side of a wall constructed of blocks shown in FIGS. 1-5;

FIG. 7 is a section taken through the wall shown in FIG. 6;

FIG. 8 is an enlarged detail taken from FIG. 7;

FIG. 9 is a perspective view of the interior side of the wall shown in FIG. 6;

FIG. 10 is an exploded perspective view of a mold assembly used in the production of blocks as shown in FIGS. 1-5;

FIG. 11 is a perspective view of the mold assembly of FIG. 10 but in partially assembled form;

FIG. 12 is a plan view of one component of a stripper shoe subassembly taken from FIGS. 10 and 11;

FIG. 13 is an end elevation of the stripper shoe subassembly of FIGS. 10 and 11;

FIG. 14 is a section taken along the line 14-14 of FIG. 15;

FIG. 15 is a perspective view of the stripper shoe subassembly shown in FIGS. 10, 11 and 13;

FIG. 16 is an end elevation of a mold core component taken from the mold assembly of FIGS. 10 and 11;

FIG. 17 is a plan view of the mold core component of FIG. 16;

FIG. 18 is a top, left perspective view of a building block in accordance with another exemplary embodiment of the invention;

FIG. 19 is a front elevation of the block shown in FIG. 18, and illustrating a moisture drainage path;

FIG. 20 is a sectional view of the block shown in FIGS. 18 and 19, but in a stack of similar blocks, where vertically adjacent blocks are reversed and inverted relative to one another, forming a wall unit;

FIG. 21 is an elevation view of a mold core used in the manufacture of the alternative block construction shown in FIGS. 18-20;

FIG. 22 is an end elevation of the mold core shown in FIG. 21;

FIG. 23 is a section taken along the line 23-23 in FIG. 21; and

FIG. 24 is a section similar to FIG. 23 but showing the block engaged with the mold core.

### DETAILED DESCRIPTION OF THE INVENTION

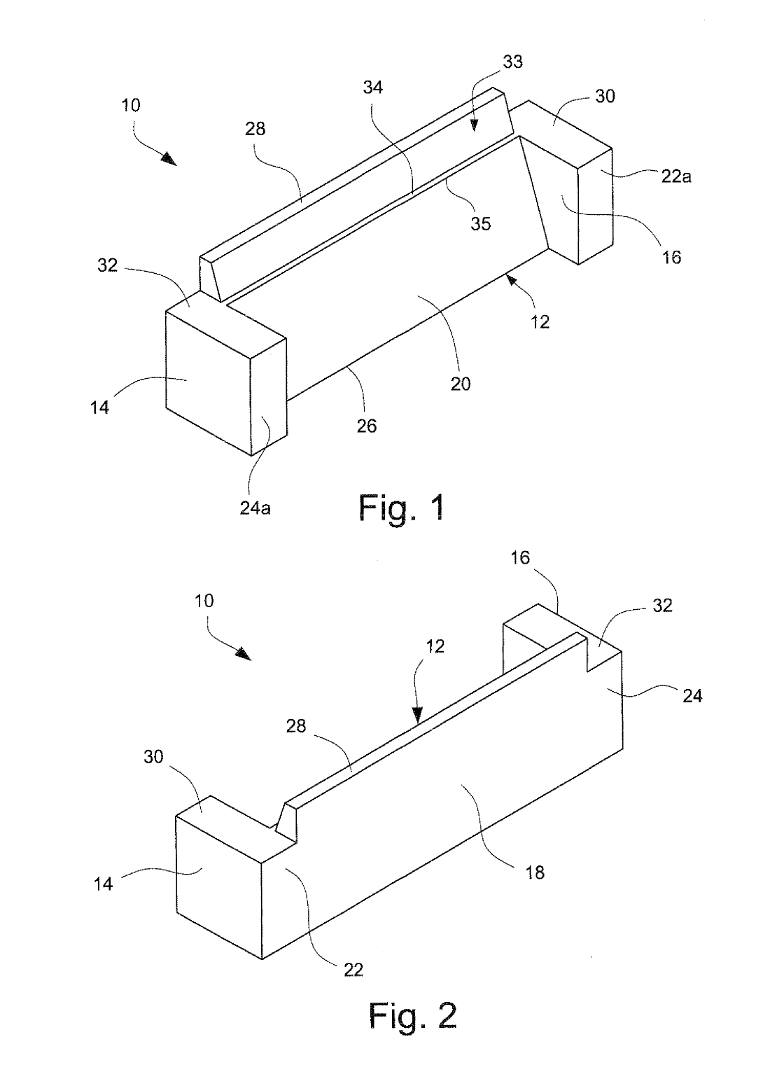

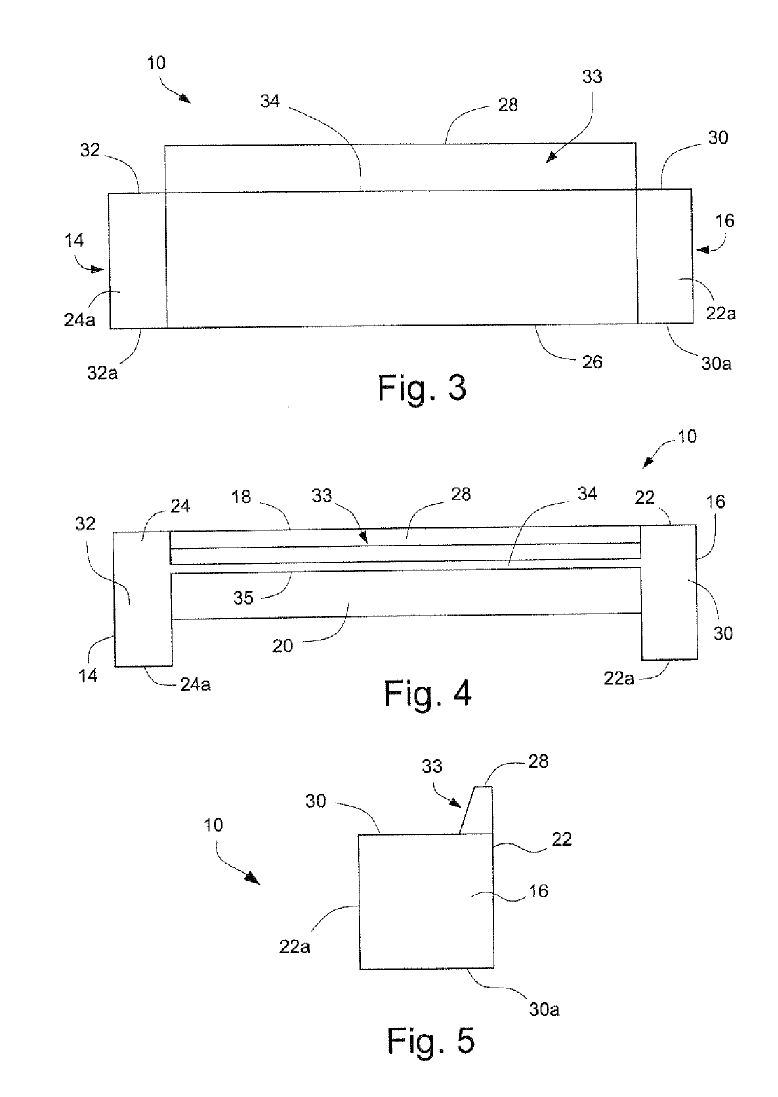

With reference initially to FIGS. 1-5, a block 10 is formed (e.g., molded) to include an elongated center portion 12 with a pair of side walls 14, 16 arranged at either end of the center portion, and substantially perpendicular thereto. For ease of understanding, the block will be described as having a front and a back, top and bottom but it will be appreciated that these terms are relative, and are not intended to be limiting in any respect. Thus, for example, in FIG. 1, the block 10 may be regarded as a top, left, front perspective view, with FIGS. 2-5 described relative to FIG. 1. Accordingly, the reference to “top”, “bottom”, “front”, “back”, “left” and “right” refers to the block in FIG. 1, with its “front” side facing forward. It will be understood, however, that adjacent upper and lower blocks are reversed and inverted on assembly, so that the characterization of the block with reference to FIG. 1 is for convenience only.

Accordingly, the center portion 12 of the block has a flat, substantially vertical back wall 18 and a sloped front wall 20. The back wall 18 is flush or co-planar with back (or first) edges 22, 24 of the side walls 14, 16, respectively. The sloped front wall 20 extends between a relatively thicker bottom wall or base 26 to a relatively thinner top wall 28, the acute slope angle preferably in the range of about 45-90° (shown at 71.3° in FIG. 5) relative to the horizontal bottom wall or base 26. The terms “thicker” and “thinner” in this context relate to the depth dimension of the block.

In this exemplary embodiment, the side walls 14, 16 extend beyond, i.e., forward of, the sloped front wall 20, and the relatively thinner top wall 28 extends above the upper (or second) edges 30, 32 of the side walls. Lower (or third) edges 30a and 32a of the sidewalls are flush with the bottom wall or base 26. A horizontal shoulder 34 extends horizontally across the sloped front wall 20 at a height substantially equal to the height of the side walls, such that shoulder 34 lies in the same horizontal plane as the upper edges 30, 32 of the side walls 14, 16. Alternatively, surface 34 could be regarded as the top surface of the block, contiguous with upper edges 30, 32, and with a truncated triangular lip 33 projecting from the surface 34, the lip inset from the front edge 35 of surface 34, but flush with the back wall 18, and extending between the inside edges of the side walls 14 and 16.

In the exemplary but non-limiting implementation of the invention illustrated in FIGS. 1-5, the block 10 may have a length (from side to side) of between about 190 mm and 460 mm (for example about 395 mm) and a depth (from front to back) of between about 80 mm and 200 mm (for example, about 92 mm). The total height of the block (from bottom to top) may be between about 80 mm and 240 mm (for example, about 124 mm). In the example shown, the lip 33 extends about 32 mm. above the side walls 30, (and surface 34). The side wall thickness may be about 38.5 mm. The center portion 12 may have a depth of about 59.9 mm. at the base 26, (in this embodiment, the forward (or fourth edges) 22a, 24a of the side walls 14, 16 are forward of the center portion), and a depth of about 12 mm. at the top edge 28. The shoulder 34 may have a depth of about 6 mm. (or, stated otherwise, the lip 33 is set back from the forward edge 35 of surface 34 by about 6 mm). The dimensions of the block may vary uniformly by scale, or differentially, depending on specific applications. It will also be appreciated that the block may be constructed of any suitable building materials including in addition to concrete, such materials as metals, plastics, resins, etc.

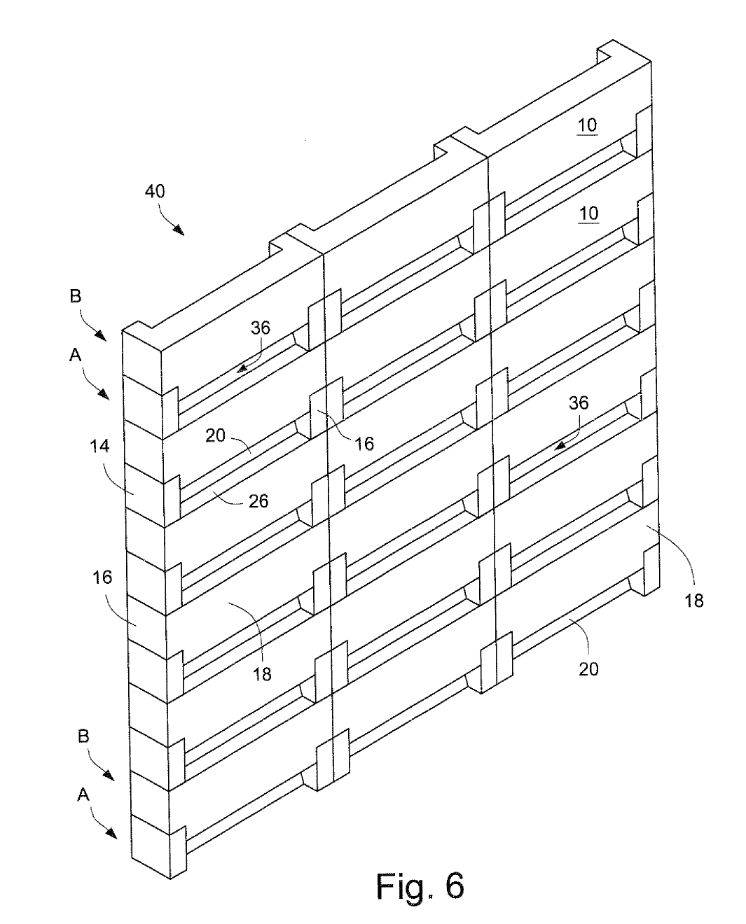

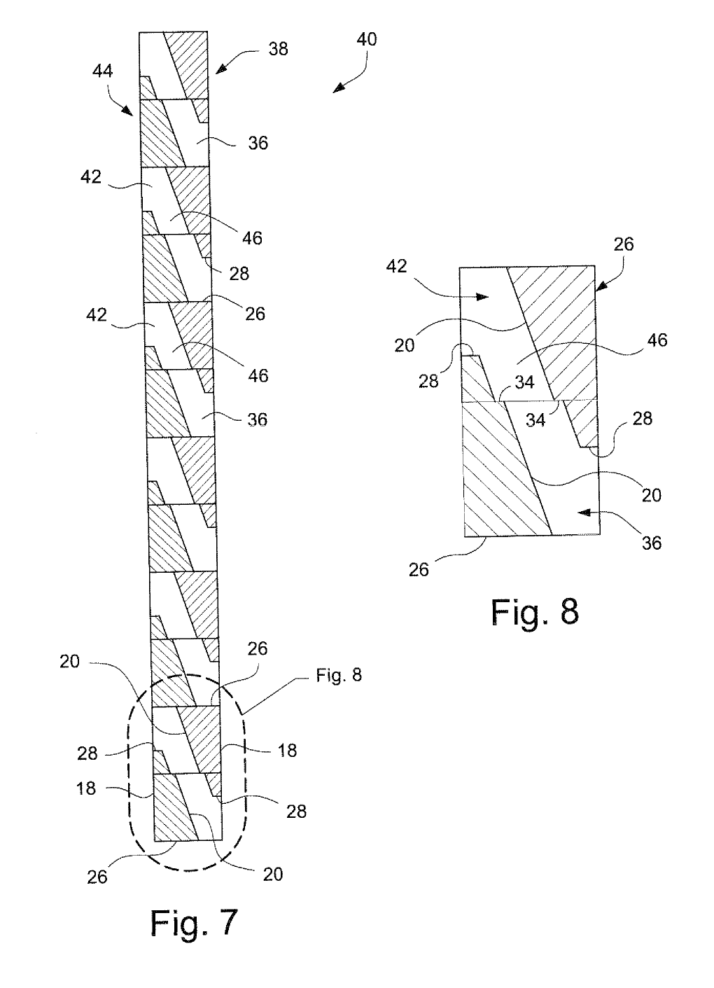

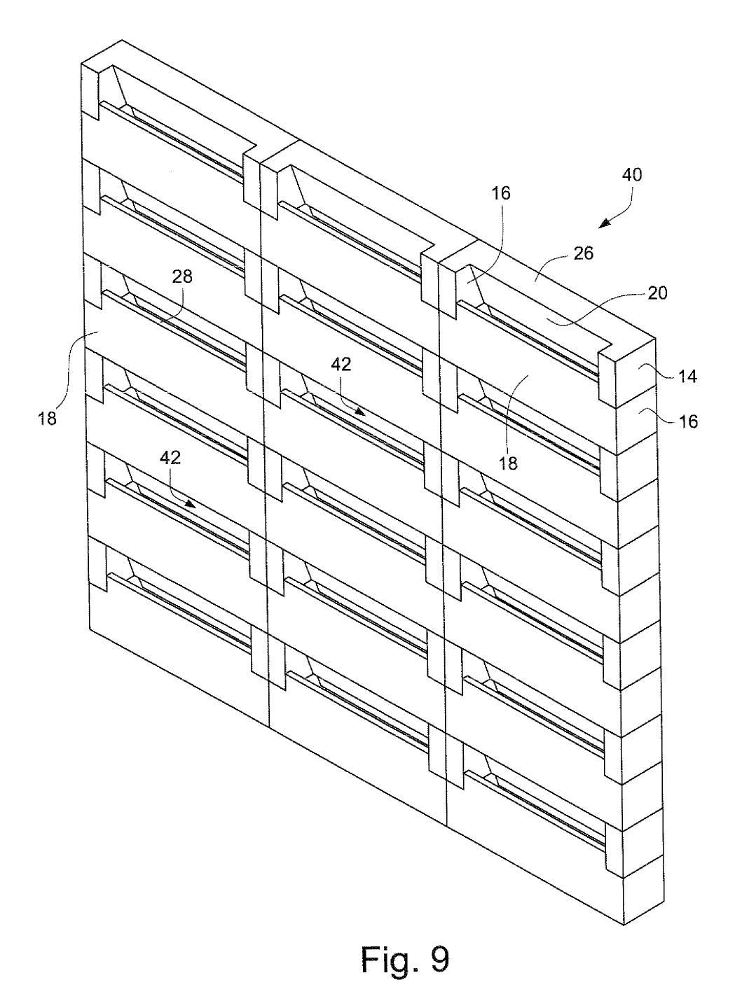

With reference now to FIGS. 6-9, a wall unit (or simply, wall) 40 may be constructed of plural blocks 10 stacked one on top of the other, but with alternate blocks inverted and reversed, i.e., rotated 180° (front to back) as shown in FIGS. 6-9. Thus, the front, back, top and bottom edges of blocks 10 in one horizontal row A of blocks in a vertically-stacked array, become the back, front, bottom and rear edges, respectively, of the next adjacent horizontal row B of blocks. The load-bearing surfaces are the top and bottom edges 30, 32 and 30a, 32a, respectively (see FIGS. 1-5), of the engaged side walls 14, 16 of adjacent blocks. Note, as best seen in FIGS. 7 and 8 that the top edge 28 of each inverted block 10 is vertically spaced from the base 26 of the next adjacent block, leaving a forward facing slot or aperture 36 on the forward (exterior) face 38 of the wall 40, and a rearward slot or aperture 42 on the rearward (interior) face 44 of the wall, connected by an upwardly and rearwardly sloping air flow passage 46 formed by adjacent sloped walls 20 of adjacent pairs of stacked blocks. Thus the forward-facing aperture 36 is vertically spaced from the rearward-facing aperture 42, so that there is no line of sight from one side of the wall unit to the other. The upwardly sloped passage 46 also prevents rain, even horizontal rain caused by excessive wind, from passing through the wall. Thus, the wall 40 has the three-fold advantage of ventilation, privacy and rain protection. It will be appreciated that the size of any individual wall unit 40 is application-dependent, but a unit made up of only two blocks is within the scope of this invention.

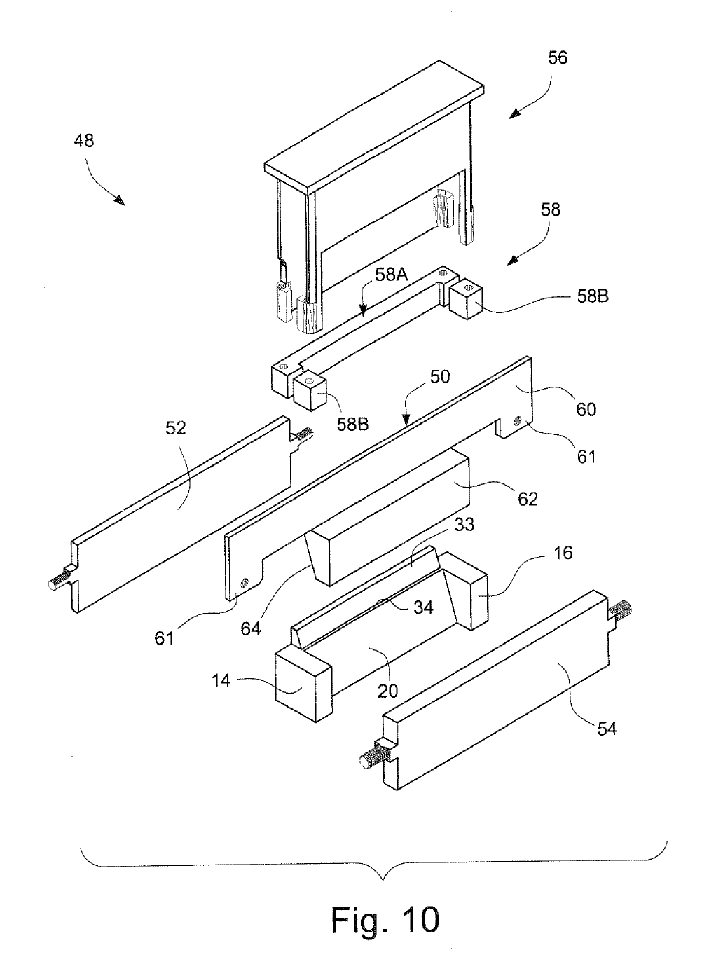

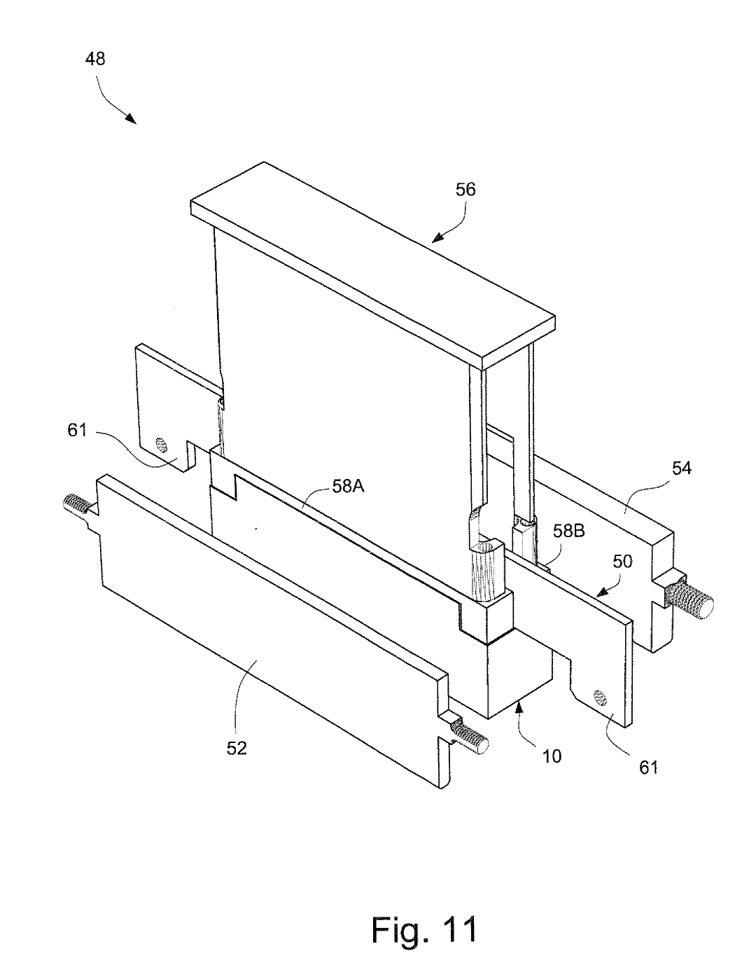

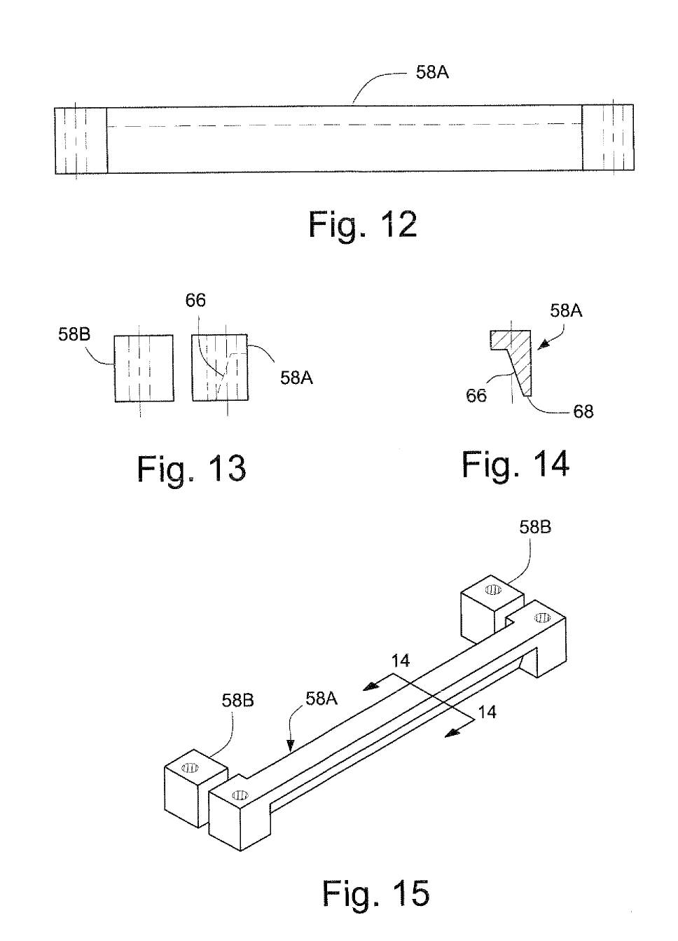

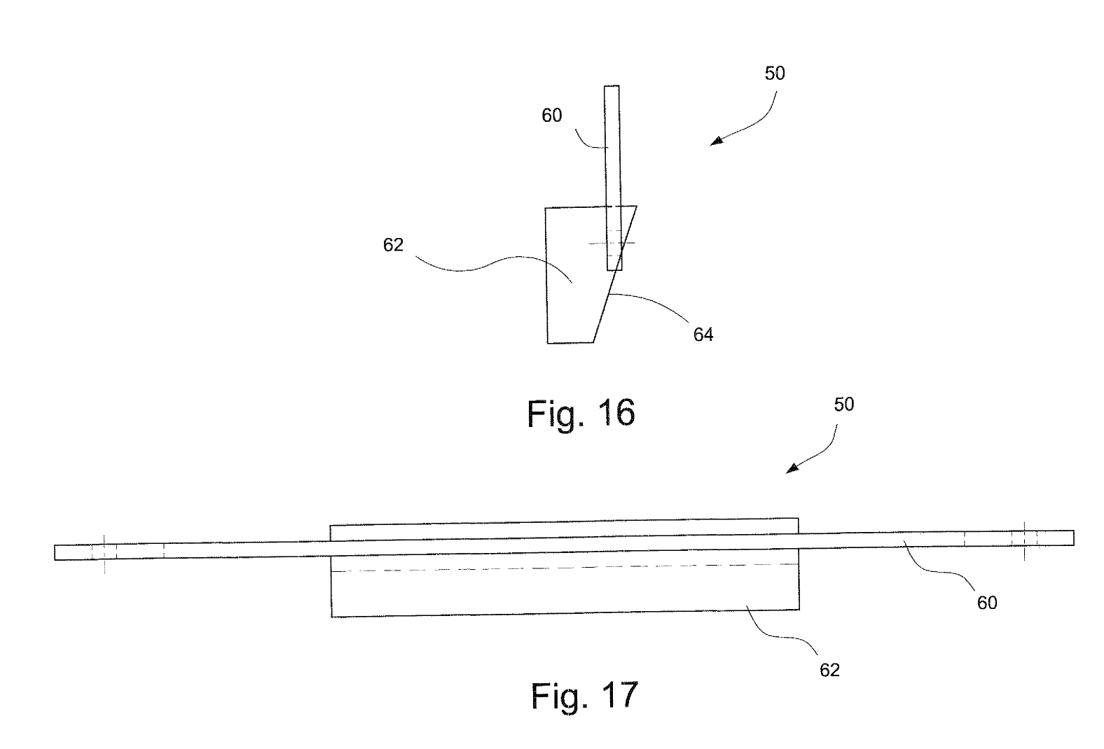

Turning now to FIGS. 10 and 11, one example of a mold assembly that could be used to form the above-described block 10 is illustrated. The mold assembly or apparatus may be used in conventional block manufacturing machines available from, for example, Besser Mfg. Co. or Columbia Machine Co. A mold assembly 48 designed especially for the block 10 may include a core 50, an outside division plate 54, an inside division plate 52, and a pair of end liners (not shown) bolted together in a mold box (also not shown). The plunger 56 and stripper shoe assembly 58 are bolted together and attached to a stripper head plate (not shown) that enables the plunger 56 and stripper shoe assembly 58 to move down into the mold box. This construction is conventional except for certain components which are designed to produce the unique block shape described above. For example, the shape of the core 50 and stripper shoe assembly 58 are specially shaped to provide the sloped wall 20 and horizontal shoulder 34. The stripper shoe assembly includes the stripper bar 58A and a pair of blocks 58B. The bar 58A and blocks 56B are adapted to be bolted to the bottom of the plunger 56 in the orientation shown in FIGS. 10 and 11, with a vertical space between the bar 58A and blocks 58B for receiving a portion of the core 50 as described below. The core 50 includes a laterally extending, vertically-oriented plate portion 60; including bolting flanges 61, and a core block portion 62. Note in this regard that the sloped surface 64 on the core block portion 62 (FIG. 10) and the continuation of that surface via the interior sloped surface 66 on the stripper shoe component 58A, best seen in FIGS. 11-13, enable formation of the sloped surface 20 and the lip 33 of the block 10, extending between the side walls 14, 16. In this regard, the lower edge 68 enables formation of shoulder 34.

In the block manufacturing process, a pallet plate (not shown) is moved into position below the mold box, and concrete is poured into the box. The mold box is vibrated to settle and uniformly distribute the concrete, and then the plunger 56 and stripper shoe 58 are moved into the box to compress the concrete while under vibration, within the confines of the inner and outer divider plates 52, 54, end liners (not shown) and about the core 50. When the block 10 has been formed, it is stripped from the mold, enabling the stripper shoe and plunger to push the finished product out of the mold box.

It will be appreciated that other block configurations are within the scope of this invention. For example, the sloped center portion may be flat as shown in FIGS. 1-5 or concave (when facing as shown in FIG. 1), and may extend at its base or bottom wall to a point behind the forward edges 22a, 24a of the side walls 14, 16 as shown in FIGS. 1-5, or may be substantially flush with the forward edges 22a, 24a of the side walls. In addition, the horizontal shoulder 34 may be omitted, with a simple transition between the sloped surface and the extended lip 33. In another variation, the front face of the lip and the sloped center portion could be co-planar.

In still another embodiment, a vertical center wall may be interposed between the side walls, extending parallel thereto, with a gap between the adjacent lip portions. This arrangement is especially suited for wider blocks where the center wall will provide additional strength.

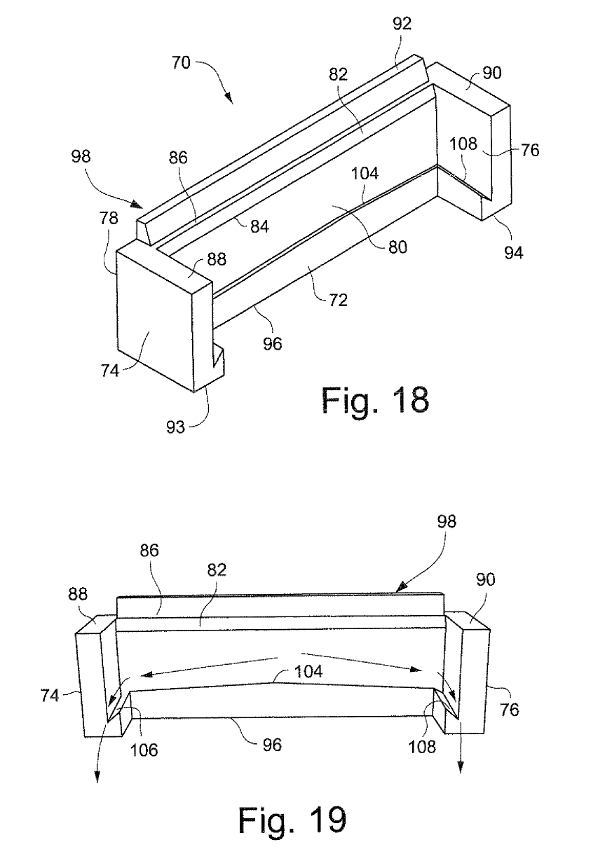

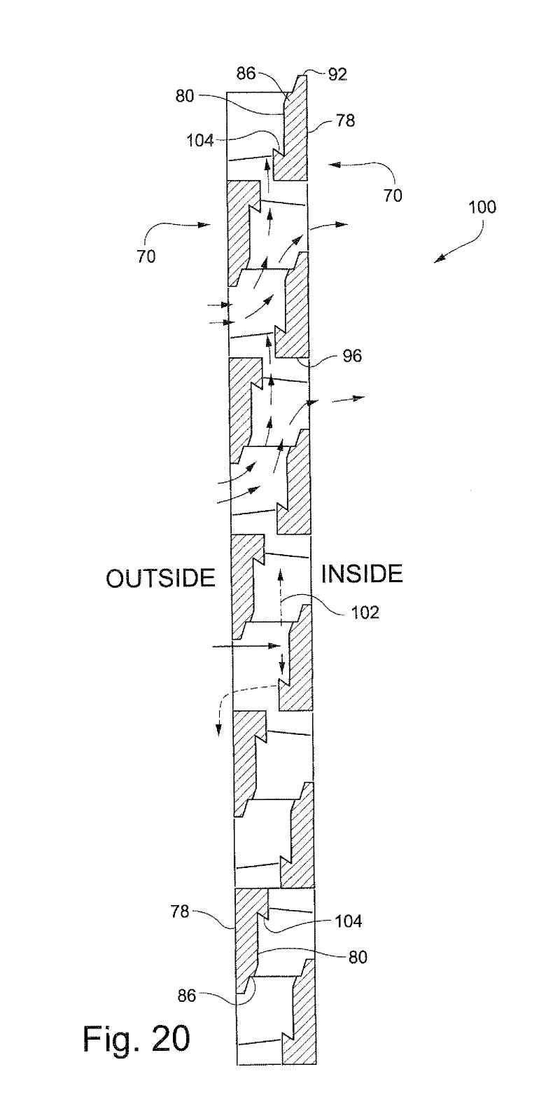

FIGS. 18-20 illustrate another exemplary but nonlimiting building block. Specifically, the block 70 is similar to that shown in FIGS. 1-9 but altered to provide enhanced ventilation as well as a moisture drainage feature. The block 70 is formed to include an elongated center portion 72 with a pair of side walls 74, 76 arranged at either end of the center portion and substantially perpendicular thereto. The center portion 72 of the block has a flat, substantially vertical back wall or surface 78 and a substantially vertical front wall or surface 80, with a tapered or sloped surface at 82 that extends from a horizontal edge or crease 84 to a horizontal shoulder 86 that is flush with the upper edges 88, 90 of the side walls 74, 76 (shoulder 86 is thus similar to shoulder 34 in FIG. 1). The sloped surface 82 and crease 84 are not necessary, however, and wall 80 could continue uniformly to the shoulder 86. On the other hand, the sloped surface 82 has a benefit in that, when the blocks 70 are assembled as a wall unit (FIG. 20), it increases the space or open area between the upper and lower opposed blocks, thereby increasing the vent volume. The back wall 78 is flush or co-planar with back edges of the side walls 74, 76, respectively, also like the embodiment shown in FIGS. 1-9.

In this exemplary embodiment, the side walls 74, 76 also extend beyond, i.e., forward of, the substantially vertical front wall 80, and the relatively thinner top wall 92 extends above the upper edges 88, 90 of the side walls. Lower edges 93, 94 of the sidewalls are flush with the bottom wall or base 96. As in the earlier described embodiment, the horizontal shoulder 86 may also be regarded as the top surface of the block, contiguous with upper edges 88, 90, of the side walls 74, 76, and with a truncated triangular lip 98 projecting from the surface 86, the lip offset in a rearward direction from the vertical front wall 80, (thus creating the shoulder 86) but flush with the back wall 78 of the block, and extending between the inside edges of the side walls 74 and 76. As in the case of sloped surface 82, the shoulder 86 could also be omitted. The shoulder 86 is provided primarily as a manufacturing safety feature. Note in this regard that if shoulder 86 (or shoulder 34 in FIGS. 1-4) were eliminated, the sloped surface 66 on the stripper shoe component would taper to a potentially hazardous knife edge. In any event, if the shoulder 86 were eliminated, the sloped surface 82 on the block would continue to the top wall 92.

With reference also to FIG. 20, when blocks 70 are vertically stacked in alternating reversed (front-to-back) and inverted relationship (similar to the stacked arrangement in FIG. 7) to form a wall unit 100, it will be appreciated that there is no overlap between the top of one block and the bottom of an inverted and reversed block, thus creating a vertical ventilation passage (indicated by arrow 102) extending the entire height of the wall, thereby maximizing ventilation by creating a “chimney effect” where outside air is pulled into the wall unit and drawn upwardly to escape at the highest point on the wall, while also permitting air to flow horizontally into the interior space behind the wall as well.

The ventilation passage, however, allows horizontal rain to impinge on the vertical wall 80 of the upright (as opposed to the inverted) blocks in a wall unit, and drip down into the next lower block where it can be blown into the interior space behind the wall. In order to prevent inward egress or migration of horizontal rain to the interior side of the wall, the substantially vertical front wall 80 and the facing surfaces of the sidewails are formed to include a rain gutter or drain. For the front wall 80, the drain is formed by a substantially V- or wedge-shaped (or generally, concave-shaped) groove portion 104 that is sloped in opposite downward directions from an approximate vertical center axis of the wall 80. The groove portion 104 is aligned and continuous with similar drain groove portions 106, 108 in the facing surfaces of the side walls 74, 76. With this arrangement, and with reference to FIGS. 18, 19 and 20 it can be seen that horizontal rain striking the front wall 80 of the “upright” blocks (those oriented as in FIGS. 18 and 19, i.e., every other block in the vertical stack of FIG. 20) will drip into the gutter or drain groove portion 104 and flow by gravity in opposite directions to the side gutters or drain groove portions 106, 108 which carry the moisture to the forward edges of the block where it then flows down the exterior side of the wall. The particular shape and slope angles of the gutter or drain groove portions 104, 106 and 108 may be varied as desired and/or as permitted by the size and configuration of the blocks. In this way, it is possible to maximize ventilation while at the same time eliminate or at least substantially minimize the risk of moisture ingress to the interior side of the wall.

As indicated above, the individual blocks 70 may be used to form walls or wall units of any desired height and width, with vertically adjacent blocks inverted and rotated front-to-back as mentioned above.

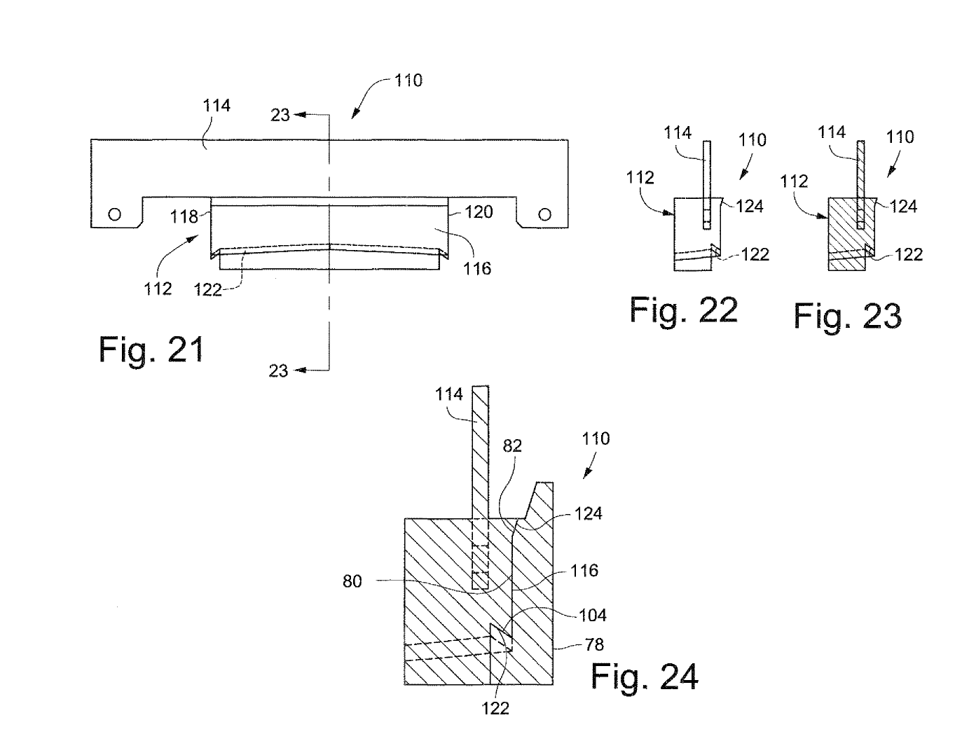

FIGS. 21-24 illustrate a mold core 110 generally similar to the mold core 50 but modified to produce the block 70 shown in FIGS. 18-20. Thus, the core block portion 112 centered along and below the plate 114 is provided with a substantially vertical surface 116 and a pair of side surfaces 118, 120. An acutely angled, substantially horizontal undercut groove 122 extends along the substantially vertical surface 116 and continues along the side surfaces 118, 120. The undercut groove slopes downwardly as viewed in FIG. 21) from a vertical center axis through the core block portion. As best appreciated from FIG. 24, the substantially vertical surface 116 and the undercut groove 122 serve to form the substantially vertical wall 80 and the drain groove portions 104, 106 and 108, respectively, of the block 70. Note that the sloped edge 124 of the core block portion forms the surface 82 of the block adjacent the shoulder 86, and would be omitted if the surface 82 were also omitted. The remaining components of the mold assembly are otherwise substantially as shown in FIGS. 10-15, and any additional modifications required in light of the altered block design are believed to be well within the skill of the art.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A building block for a ventilated wall comprising:
an elongated center portion flanked by a pair of substantially parallel side walls oriented substantially perpendicularly to said center portion, said center portion having upper and lower edges, a first substantially vertical rear wall and a second substantially vertical front wall, said substantially parallel side walls extending beyond said second substantially vertical front wall; and a first drain groove portion extending across said substantially vertical front wall and aligned with second and third drain groove portions provided on respective facing surfaces of said substantially parallel side walls.

2. The building block of claim 1 wherein said first drain groove portion slopes downwardly in opposite directions from an approximate vertical center axis of said substantially vertical front wall.

3. The building block of claim 2 wherein said second and third drain groove portions are sloped downwardly to said forward edges of said side walls.

4. The building block of claim 1 wherein a truncated-triangle-shaped upper lip extends above an upper surface of said center portion, said upper lip rearwardly offset from a forward edge of said upper surface, thereby creating a horizontal shoulder across said substantially vertical front wall, spaced above said first drain groove portion.

5. The building block of claim 1 wherein said horizontal shoulder is substantially flush with upper surfaces of said side walls.

6. The building block of claim 1 wherein said block is constructed of any one of a group of materials comprising metals, plastics, resins or concrete.

7. The building block of claim 1 wherein said first, second and third drain groove portions are substantially concave-shaped.

8. A building block for a ventilated wall comprising:
an elongated center portion flanked by a pair of substantially parallel side walls oriented substantially perpendicularly to said center portion, said center portion having upper and lower edges, and said side walls having upper and lower edges substantially flush with the upper and lower edges of said center portion, said center portion further comprising a first substantially vertical rear wall and a second substantially vertical front wall, said substantially parallel side walls extending beyond said second substantially vertical front wall; and a first drain groove portion extending across said substantially vertical front wall between said upper and lower edges of said center portion and aligned with second and third drain groove portions provided on respective facing surfaces of said substantially parallel side walls, said second and third drain groove portions extending to forward edges of said side walls; said first, second and third drain groove portions configured to carry moisture by gravity to said forward edges of said side walls.

9. The building block of claim 8 wherein said first drain groove portion slopes downwardly in opposite directions from an approximate vertical center axis of said substantially vertical front wall.

10. The building block of claim 8 wherein said second and third drain groove portions are sloped downwardly toward said forward edges of said side walls.

11. The building block of claim 8 wherein a truncated-triangle-shaped upper lip extends above an upper surface of said center portion, said upper lip rearwardly offset from a forward edge of said upper surface, thereby creating a horizontal shoulder across said substantially vertical front wall, spaced above said first drain groove portion.

12. The building block of claim 8 wherein said block is constructed of any one of a group of materials comprising metals, plastics, resins or concrete.

13. A wall unit comprising:
at least first and second building blocks, each building block having an elongated center portion flanked by a pair of substantially parallel side walls oriented substantially perpendicularly to said center portion, said center portion having upper and lower edges, a first substantially vertical rear wall and a second substantially vertical front wall, said substantially parallel side walls extending beyond said second substantially vertical front wall; and a first drain groove portion extending across said substantially vertical front wall and aligned with second and third drain groove portions provided on respective facing surfaces of said substantially parallel side walls, said second and third drain groove portions extending to forward edges of said side walls; and wherein said at least first and second building blocks are stacked one on the other, with said second block inverted and reversed relative to said first block.

14. The wall unit of claim 13 wherein the side walls of vertically adjacent stacked blocks are engaged, and wherein a continuous substantially vertical ventilation passage is established between the side walls of said vertically adjacent stacked blocks.

15. The wall unit of claim 13 wherein said first drain groove portion slopes downwardly in opposite directions from an approximate vertical center axis of said substantially vertical front wall.

16. The wall unit of claim 15 wherein said second and third drain groove portions are sloped downwardly toward said forward edges of said side walls.

17. The wall unit of claim 13 wherein said second and third drain groove portions are sloped downwardly toward said forward edges of said side walls.

18. The wall unit of claim 13 wherein said at least two blocks comprise more than two blocks in a vertical stack.

19. The wall unit of claim 13 wherein said at least two blocks comprise plural vertical stacks of said blocks in side-by-side relationship.

20. The wall unit of claim 8 wherein each block is constructed of any one of a group of materials comprising metals, plastics, resins or concrete.

21. A mold assembly for forming a ventilated construction block, the mold assembly comprising a mold core having a centrally-located block portion attached to an underside of a core plate portion, the block portion having a substantially vertical surface and a pair of side surfaces; and an undercut, substantially horizontal groove extending along said substantially vertical surface and continuing along said pair of side surfaces, said undercut groove sloping downwardly from a vertical center axis of said block portion of said mold core.
